(19) United States
(12) Patent Application Publication
(10) Pub. No.: US 2025/0315776 A1
(43) Pub. Date: Oct. 9, 2025

(54) METHODS AND DEVICES FOR CARGO TRACKING AND/OR MONITORING

(71) Applicant: Globe Tracker ApS, Copenhagen (DK)

(72) Inventors: Mark Oudshoorn, Sarasota, FL (US); James Tout, Sarasota, FL (US); Richard Meyers, Sarasota, FL (US)

(21) Appl. No.: 19/172,570

(22) Filed: Apr. 7, 2025

Related U.S. Application Data
(60) Provisional application No. 63/575,460, filed on Apr. 5, 2024.

(51) Int. Cl. G06Q 10/0833; B65D 90/48

(52) U.S. Cl. CPC G06Q 10/0833; B65D 90/48

(57) ABSTRACT

Detectors monitor closure conditions of containers with a door sensor. Other sensors have different positionings, such as inside and/or outside the containers. The detectors may include communications modules and transceivers on an outside of the container to communicate outside the container, with photovoltaic cells to power the systems. The detectors may include sensors on an inside of the container all in a single body that passes through a container wall or wraps around a door of the container. Interior sensors may monitor air temperature or humidity or presence or position of cargo loads in the container. Detectors are also useable with any number of communications ports, antennae, batteries, processors, and movement sensors to operate the same. While detectors may face all of inside, outside, and closing surfaces of the container, they secure to the container without impeding access to or opening/closing of the container.

### RELATED APPLICATIONS

This application claims priority under 35 U.S.C. § 119 to co-pending U.S. Provisional Application 63/575,460, filed Apr. 5, 2024 and incorporated by reference herein in its entirety.

### BACKGROUND

FIG. 1 is a perspective view of a related art shipping container 10, such as an ISO 830, 668, and/or 1496 complaint container for shipping cargo aboard vessels, trains, and/or as trailers. As seen in FIG. 1, generally impermeable, rigid walls 12 make up the shape of container 10, with the only access point being door 11 that securely opens and closes container 10. An exterior location device 20, such as a transponder, GPS device, cellular communicator, etc. can determine and/or transmit a location or presence of container 10. Device 20 may be affixed to an exterior of walls 12 to move securely with container 10 while maintaining exposure to external location or presence receivers.

FIG. 2 is front view of related art shipping container 10, showing door 11 opened and an interior within walls 12. The space inside container 10 may hold numerous different types of cargo for shipping securely with door 11 closed. Internal monitor 25 may be placed on an interior of container 10 and measure storage conditions like temperature, humidity, light, etc. and record the same to ensure cargo inside contain 10 has been preserved at delivery.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include detector systems installable with shipping and cargo containers using multiple oriented sensors to detect different conditions, including the status of an opening of the containers with a door sensor. For example, a door system may include an inductive coil to generate an electrical signal from relative movement of a door bearing a magnetic or electrical field, which can be related to door position. The door sensor may face the door or a wall that will relatively move, while another sensor or component in the system may face outside of the shipping container when installed. For example, a GPS sensor or solar panel may be open to the outside to determine position and power or charge the system. Further sensors may be open to an interior of the container, such as temperature, humidity, and/or fill sensors configured to determine whether container conditions are dangerous or normal for cargo therein. Example embodiment sensor systems may pass around or through container walls or doors to allow the container to be opened, closed, and sealed and without blockage. Example embodiment sensor systems may further include communications ports, antennae, batteries, processors, movement sensors, and any additional components at any orientation internal or external to the container.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art shipping container.

FIG. 2 is a front illustration of the related art shipping container in an open door configuration.

FIG. 3 is a schematic illustration of an example embodiment sensor.

FIG. 4 is an exploded view of an example embodiment sensor.

FIG. 5A is a front view of the example embodiment sensor of FIG. 4.

FIG. 5B is a detail view of the example embodiment sensor of FIG. 5A.

FIG. 6 is an exposed view of an example embodiment sensor.

FIG. 7A is a perspective view of a container door in an example method of installing a sensor.

FIG. 7B is an installed view of the sensor in the container door of FIG. 7A.

FIG. 8 is an exploded view of an example embodiment sensor.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized that multiple door and container characteristics need to be remotely monitored without personnel intervention or interfering with container integrity, operability, or seal. This is true for all containers, including shipping containers described in ISO 830, 668, and 1496. Yet containers are often mobile and moving through areas with little monitoring capability, and owing to their sealed nature, prohibit easy monitoring without significant signal degradation and/or container structural compromising. To overcome these newly-recognized problems as well as others, the inventors have developed example embodiments and methods described below to address these and other problems recognized by the inventors with unique solutions enabled by example embodiments.

The present invention is storage container sensors, containers bearing the same, and methods of installing and using the same. In contrast to the present invention, the few example embodiments and example methods discussed below illustrate just a subset of the variety of different configurations that can be used as and/or in connection with the present invention.

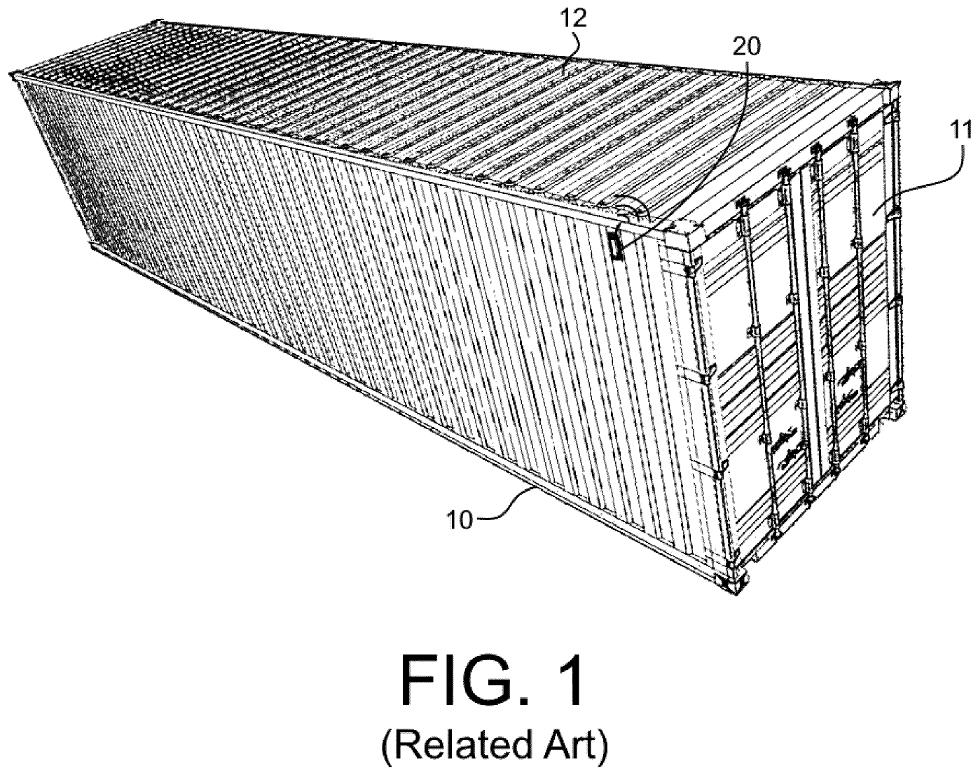

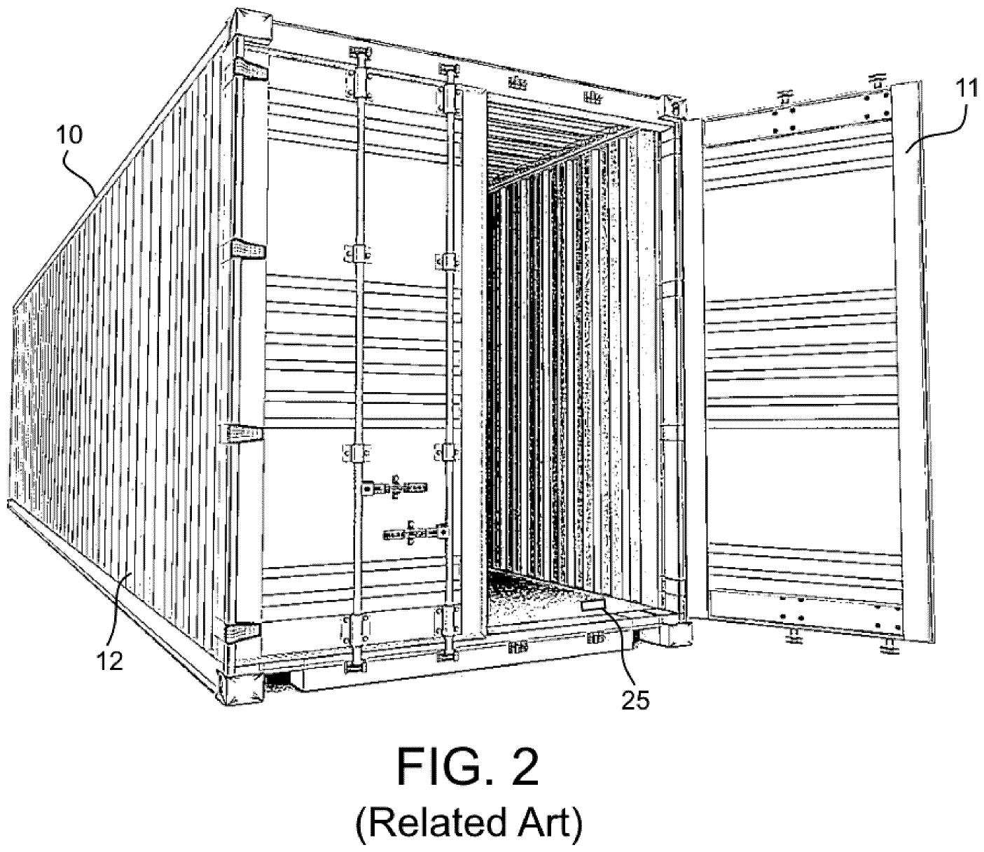

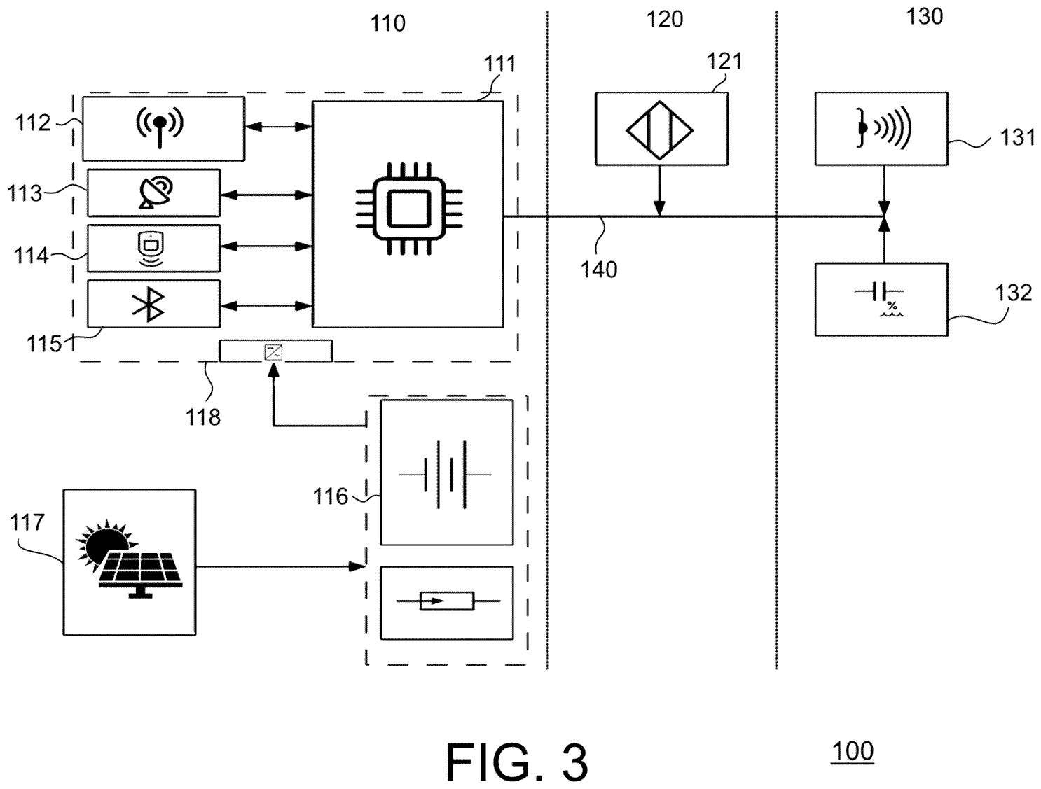

FIG. 3 is a schematic illustration of an example embodiment container sensor 100 useable with shipping containers like those shown in FIGS. 1-2 and any other container for bearing cargo with a closeable door. As shown in FIG. 3, sensor 100 includes multiple faces 110, 120, and/or 130, including at least one face 120 having door sensor 120 arranged with a door or wall of the container to detect presence and/or movement of the same. For example, sensor 121 may be in one wall 12 or door 11 (FIGS. 1-2) and face an opposite door 11, such as in the jamb between the door or sensing into the space where a door may be located. Door sensor 121 may be any type of sensor capable of detecting that a door of the container is open and/or closed, including by position or movement. Door sensors 121 may be very high reliability systems that are difficult to tamper with, or defeat. Door sensors 121 may also be very low power systems which allows continuous monitoring without depleting battery life. This may reduce and identify cargo theft incidents, insertion of contraband or contamination, and also allow monitoring of normal load/unload operations and inspections.

As one example of door sensor 121, an inductive sensor, such as an inductive coil with converter for the induced current from the coil, may detect movement of a door having magnetic material or carrying an electric field. For example, a coil of sensor 121 may be placed in the door jamb of a container to detect adjacent metal of an opposite mating door. In this instance the door makes the core of the inductor. As the door is opened, the core moves and the inductance changes, which may be used to determine movement on the doors by sensor 121.

One of the other faces of example embodiment container sensor 100 may be exterior face 110. For example, exterior face 110 may be on or open from an outside of wall 12 or door 11 of container 10 (FIGS. 1-2). Exterior face 110 includes communication devices for processing, storing, and/or transmitting indications from door sensor 121. Communications may include a cellular module such as a Cat M1, NB1, NB2, and/or 2G fallback transceiver to provide global two-way communications, a GNSS Receiver providing position reports and/or a cloud server to establish geozones to assist with container operations, and/or Bluetooth wireless LAN, LPWAN, and/or LoRaWAN for interfacing to peripherals and/or sensors. For example, exterior face 110 may include one or more antennas or communications ports configured to transmit and/or receive wired or wireless communications to device 100. This may include GPS antenna 113 potentially oriented at an angle to achieve maximum view of clear sky for reliable and accurate GPS operation or other communications. Bluetooth module 115 may connect to a cellular phone for an installation app or remote sensors utilizing a Bluetooth link layer. Cellular or other local antenna 112 and associated modem may permit network connections like LAN access and Wi-Fi and/or SG data communications.

While any of the above antennas may be used in other faces, use in exterior face 110 may further improve operation of GPS and communications in cases where example embodiment sensor 100 is used on a container that is stacked or otherwise positioned in an area with signal may be blocked. Motion sensor 114 may also be in any section and can be used to monitor container movements during transit or port operations, as well as to modify the reporting intervals based on movements, to preserve and maximize battery life. For example, motion sensor 114 may be an accelerometer, inertial measurement unit (IMU), and/or gravity detector to determine container impacts, g-force of the shock to alert users of potential cargo damage, tilt of orientation of the container, motion of the container, etc.

Exterior face 110 may also include solar panel 117 powering rechargeable battery 116 and/or any other component of sensor 100. potentially capable of operating for 7-10 years under typical shipping conditions. Solar panel 117 may so power and charging in sunlight conditions from exposed face 100. Battery 116 may be paired with appropriate current limiting and power supply conversion circuits to ensure connection to, and adequate powering and/or charging from, panel 117 without damage to any component. For example, battery 116 may be a lithium ion rechargeable battery operating at 6600 or 4400 mah, and solar panel 117 may be a 1.2 Watt solar panel, providing all necessary charging and operations.

Computer, such as microprocessor 111 together with any other software, hardware, and firmware, may coordinate and operate any component of sensor 100. Operating parameters may be adapted and changed based on instructions or information received from communications ports like sensors and antennas. Example programming may include scheduling of reporting intervals and reporting data wirelessly, record accelerometer data, and/or manage door, distance, temperature, humidity, and any other sensors. For example, microprocessor in may be a 32-bit microcontroller with attendant memory storing data structures that causes the processor to execute these tasks. Example embodiment sensor 100 may keep track and monitor certain condition of shipping containers with their sensors and/or return parameters to a cloud based UI, for example. The cloud platform can also be configured with analytics, AI on individual containers, or fleet based analytics.

One of the other faces of example embodiment container sensor 100 may be internal face 130, which may be open to an interior of the container and detect conditions of cargo. One or more internal cargo sensors, such as a microwave sensor 131 and/or a temperature and/or humidity sensor 132 may be in the internal face to measure such qualities inside the container. For example, these sensors may measure container empty/full/degree fill, interior temperature, and/or humidity. Temperature and/or humidity sensor 132 may be in a sealed cavity with and opening in the outside of the case to expose the sensor to external environmental conditions as well. Any internal or external opening to sensor 132 may be covered by a hydrophobic membrane.

Microwave sensor 131 may include an RF lens and operate as a microwave pulsed coherent radar module, with the RF lens paired with an emitter module to allow distance sensing. The lens may be plastic and shape the microwave or other EM radiation into a beam to allow breaking and/or distance detection. If sensor 131 “sees” the back wall of the container, it may report the same and indicate the container is empty. Microwave sensor 131 operating as a load sensor may be self-calibrating, capable of operation in containers of varied sizes and capacities. Example embodiment devices may also be used to monitor and track refrigerated containers.

All faces 110, 120, and 130, and components operating therein, may be communicatively connected and/or powered and controlled through bus 140. For example, a flexible circuit board like Kapton may operate as bus 140 by wrapping continuously around door portions, powering and communicating between all components as a single unit of sensor 100. In this way, external components, such as communications module 112 or GPS antenna 113, may be connected to and communicate with door sensor 121 internal to a door jamb, which may all be connected to and communicate with an internal temperature or humidity sensor 132, and/or position sensor 131, like a microwave beam detector. These sensors, communications, power, and processor, can all be fit into a containing package with appropriate division and sealing away from typical shipping container environmental conditions, including lengthy external exposure to challenging maritime and/or movement conditions.

Similarly, internal encapsulation 118, such as explosion-proofing or potting compound for power circuits. Example embodiments may be safety certified in accordance industry standards such as ATEX and/or UL913 for operation around explosive atmosphere conditions and/or dangerous goods. Any modem module for antenna 112 may also be within internal encapsulation 118 because of its current consumption. Bus 140 may extend through all encapsulation 118, such as an underlying Kapton or other circuit board, passing under each encapsulated section.

Example embodiments may incorporate all components in a single integrated package or within fewer interrelated modules. Similarly, while processor 111 includes at least one hardware processor and associated memory such as a cache, transient memory, and read-only memory, as well as necessary busses and input/output ports, processor 111 may include multiple discrete processors or chips, potentially remotely located and in wireless communication with the remainder of sensor 100. Any memory may also be local and/or remote and may be, for example, random access memory, read only memory, programmable read only memory, erasable programmable read only memory, electronically erasable programmable read only memory, flash memory, a hard disk, a processor cache, optical media, and/or other non-transient computer readable media.

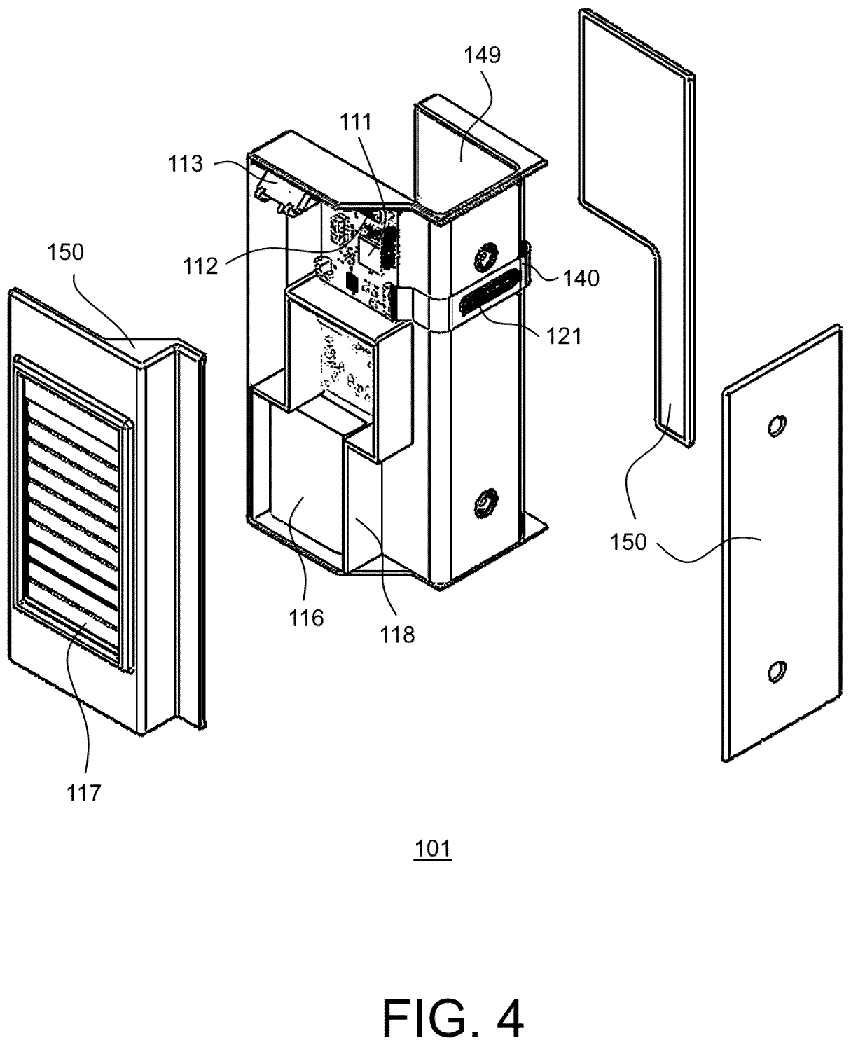

The examples of FIGS. 4-8 illustrate how example embodiment sensor 100 may be fabricated as and/or used with shipping containers and structures of any shape, size, and/or standardization, at any point in time. For example, an example embodiment sensor may be installed or removed from an existing, standard freight container that is loaded and shipped on a vessel, by securing an example embodiment tracker to a door or other structure. Similarly, example embodiment containers may be fabricated with gaps, potentially filled with a blank, in doors or other structure to allow insertion of an example embodiment tracker flush with other surfaces of the same.

As shown in FIG. 4, example embodiment sensor 101 may include all the elements of sensor 100 in one example configuration. In example embodiment sensor 101, all door and internal sensors, casing, and other components may be fully external to, and wrap around, a door surface or other structure about the doorjamb. Door sensor 121 may be in a middle, door-facing. Top and bottom flaps on one or opposite sides on sensor 121 in this portion may prevent crushing or impact on the sensor.

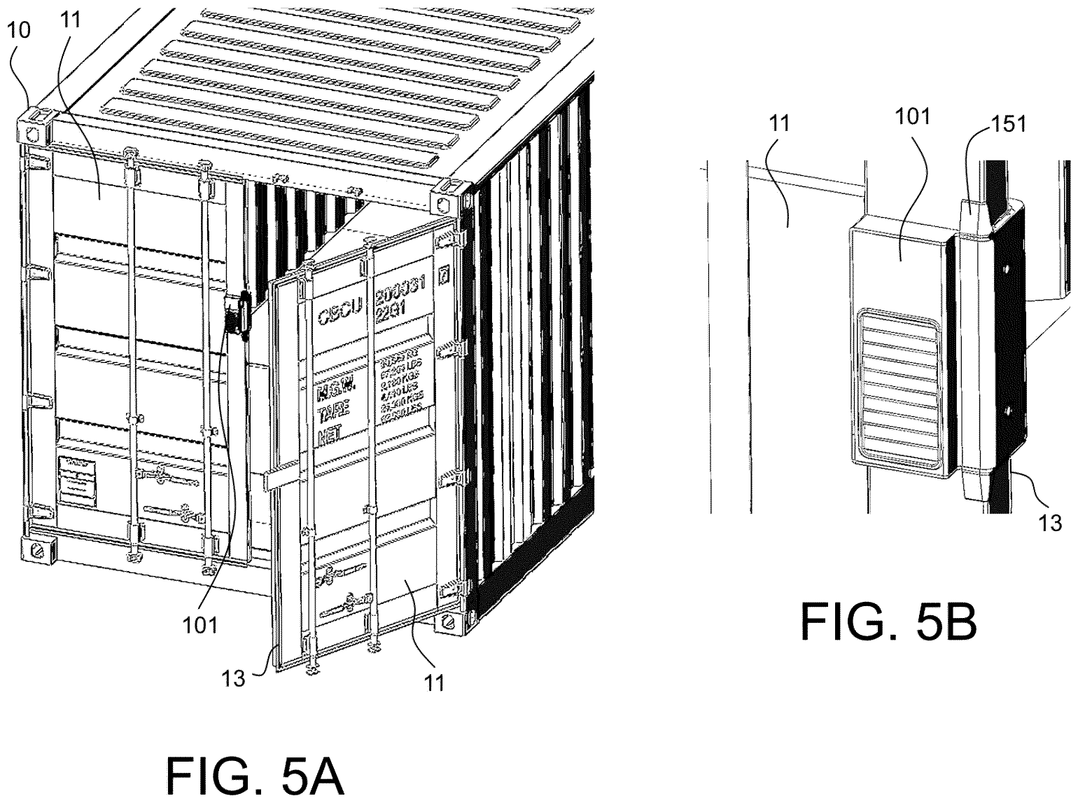

For example, sensor 101 may use a U-shaped package shaped with a central opening large enough to wrap around a door while continuing to maintain the door seal. As seen in FIG. 5B, this packaging allows load and temp/humidity sensor(s) on an internal face to remain the inside of the container, door sensor on a door face to be in the jamb of the door, and power, communications, and other electronics to be on the outside of the door. Example embodiment may reduce the ability for tampering based on the case design and shape, while not allowing easy access to the door sensor to increase the difficulty to defeat the system. As seen in FIG. 5A, example embodiment sensor 101 may be sized to fit along an edge of door 11 without impacting any other securing bars or braces on door 11.

As seen in FIG. 5B, transition pieces 151, such as EPDM gaskets shaped to typical door seals 13, may ensure that any portion of example embodiment that passes through a door jamb and seal still maintains container seal 13 on doors 11 when closed. Sensor 101 has external dimensions shaped to fit in between the clearance of the left and right doors 11 of the container 10, thick enough to provide structural integrity, yet thin enough to not interfere with door operation or seal 13, such as a weather gasket, protecting the container from outside elements. This may reduce and identify cargo theft incidents, insertion of contraband or contamination, and also allow monitoring of normal load/unload operations and inspections.

As seen in FIG. 4, sensor 101 may use internal form 149 with casing pieces 150. Internal form 149 may be a single bent metal or other rigid form, shaped to be installed on any container door, including any standard ISO compliant ocean container. For example, internal form 149 could be a single anodized or coated aluminum body, or other metal or material compositions. Casing pieces 150 may be any resilient material, such as hardened plastic or over-mold that can withstand harsh condition and provide tamper resistant robust operation. Casing pieces 150 may include openings for any component, such as solar panel 117 on an exterior face, or humidity/temperature sensor 132 on an internal face, as well as openings for securing or joining sensor 101 to any container. Casing pieces 150 may also be open for, or directly house, lenses, contact pieces, or other operation components for sensors 121 and 131.

As shown in FIG. 5B, example embodiment sensor 101 may be mounted using two screw to permanently secure it to container door 11, or alternatively it can be removable or modular and used for as a per-trip application to monitor high value or delicate cargo using a temporary installation like a clamp, adhesive, or frictional seating with door 11 and/or container wall 12.

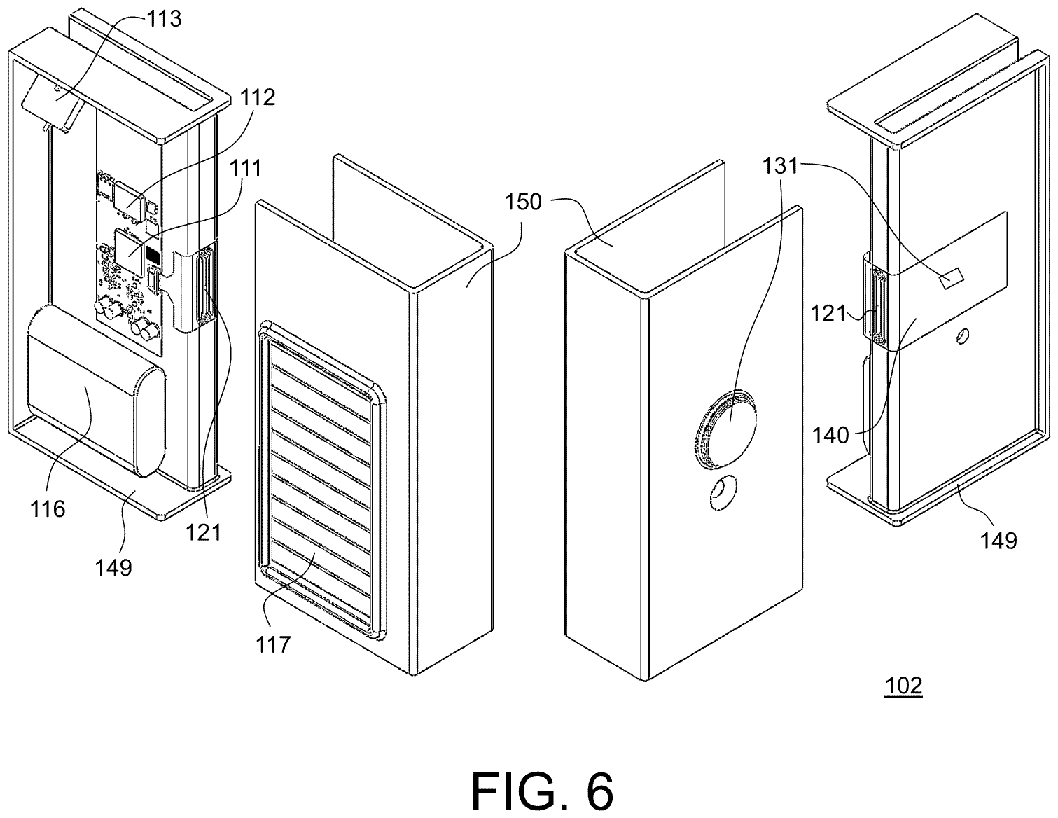

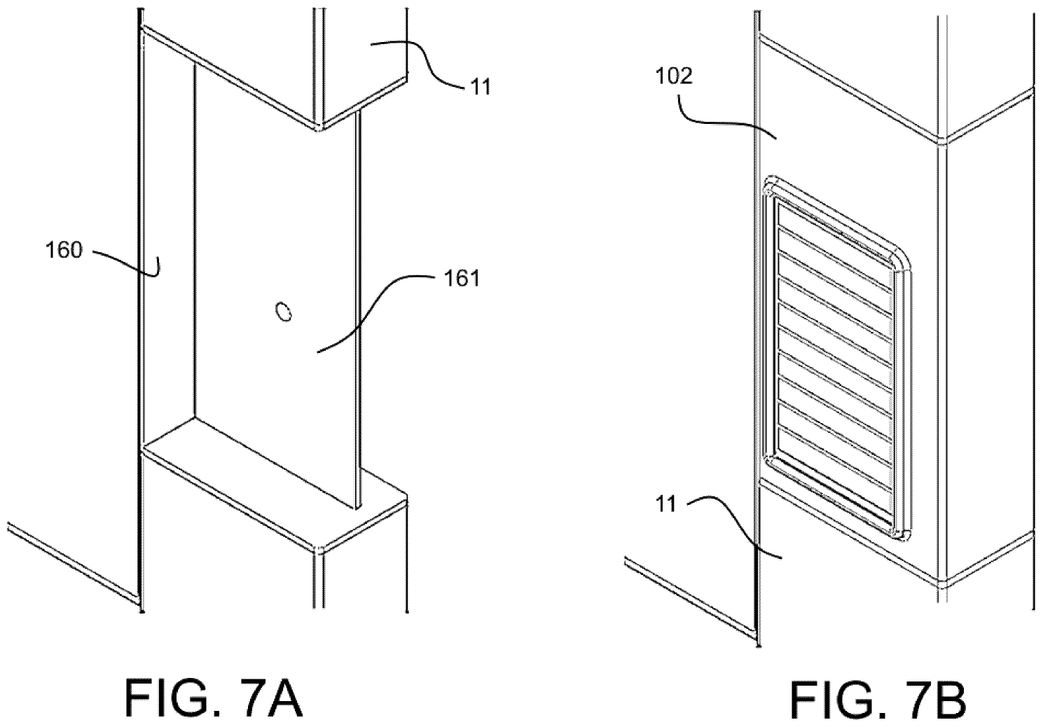

As shown in FIGS. 6-8 example embodiment sensor 102 may include all the elements of sensor 100 in one example configuration. In example embodiment sensor 102, these elements may be internal to, or flush with, a surface, such as a door surface or container wall surface. For example, as shown in FIG. 7A, an inset gap 160 from a door edge, which may be cut, machined, forged, stamped, etc. from the same, may allow insertion and securing of I-beam or central column 161 for an example embodiment sensor. A blank may be initially placed in such gap 160 and removed, allowing for easy swapping with sensor 102, all while keeping the container structurally close-able.

As shown in FIG. 6, sensor 102 may have a shape to fit around or mate with I-beam or central pillar 161, with sensors, communications, circuit board, etc. all connected and mounted around internal form 149 so as to interface with both container internals and externals. In this example internal form 149 may have a narrower U shape or may be pillar 161 itself, all internal to a door or other surface in which it is installed. Casing pieces 150 may further join to pillar 161, the door or surface, and/or internal form 149 and be flush with the surface to provide a seamless exterior when installed. Internal form 149 may be fixed or removable, such as by a tension or friction fit within the door, or by welding or other fasteners.

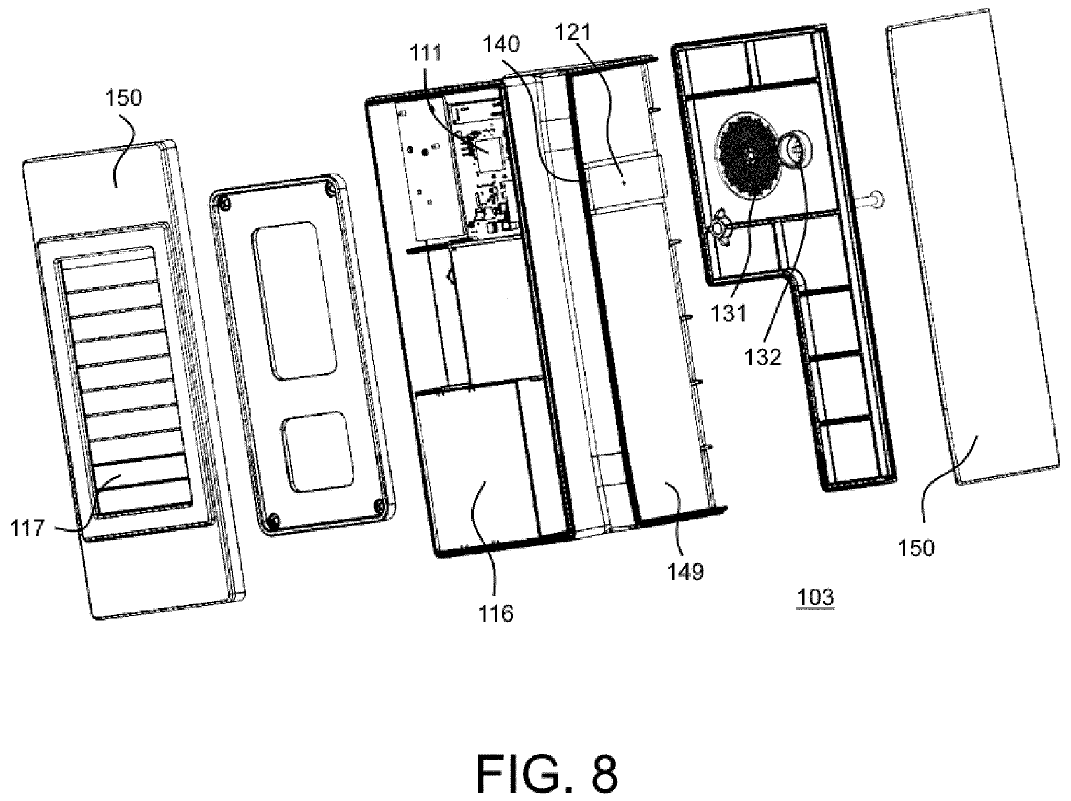

As shown in FIG. 8, another example embodiment sensor 103 having any of the components of example sensor 100 may fit with a bolt fastener passing through all of internal form 149, casing pieces 150 and any door or surface element fitting next to form 149.

Example embodiment sensors 100 may be easier to install, less expensive to build, provide higher security, and/or provide more data to the operator or shipping line. For example, example embodiments may be simply installed in around 1 minute thereby reducing installation and labor costs, reducing the use of ladders for safety, and reducing container down-time.

Some example embodiments and methods thus being described, it will be appreciated by one skilled in the art that examples may be varied through routine experimentation and without further inventive activity. For example, although some two-doored shipping containers are the target of some example embodiment sensors and methods of use, it is understood that any other shapes and sizes as well as container configurations are useable with example embodiments and methods. Variations are not to be regarded as departure from the spirit and scope of the example embodiments, and all such modifications as would be obvious to one skilled in the art are intended to be included within the scope of the following claims.

1. A sensor package for use through a shipping container that opens and closes with a moveable door, the sensor package comprising:
a door sensor configured to sense door presence in a first direction, wherein the sensor package is open to an exterior of the shipping container when installed.

2. The package of claim 1, wherein the door sensor is an inductive coil configured to generate a signal from material movement of a door to which the package is not secured.

3. The package of claim 1, wherein the package has a U shape with a shortest portion of the U facing in the first direction and a leg of the U facing in a second direction different from the first direction, wherein the sensor package is open to an exterior of the shipping container when installed.

4. The package of claim 1, wherein the package is configured to allow the door of the shipping container to open, close, and seal freely and without interference from the package.

5. The package of claim 1, wherein the package is configured to affix to the container adjacent to the door.

6. The package of claim 1, wherein the shipping container includes two doors configured to close together at a jamb, and wherein the package is configured to attach to one of the two doors and pass through or form the jamb.

7. The package of claim 1, wherein the package further includes:
a solar panel open to the exterior; and
a battery configured to power the cargo sensor and be powered by the solar panel.

8. The package of claim 1, further comprising:
a cargo sensor configured to sense a condition of the cargo in the container in a second direction different from the first direction.

9. The package of claim 1, further comprising:
a GPS antenna configured to receive GPS signals indicating a position of the package; and
a processor configured to control the package.

10. The package of claim 1, wherein the package is configured to sense at least one of internal temperature, humidity, and cargo presence or placement within the container.

11. A method of monitoring a shipping container, the method comprising:
attaching a sensor assembly to the container such that the sensor assembly has a first surface exposed to an interior of the container and a second surface exposed to an exterior of the container with material continuity between the first surface and the second surface.

12. The method of claim 11, further comprising:
sensing at least one of internal temperature of the container, internal humidity of the container, light conditions of the container, payload presence within the container, and GPS position of the container with the sensor assembly.

13. The method of claim 11, wherein the sensor assembly has a third surface facing a door jamb or a thinnest plane of a door of the container.

14. The method of claim 13, wherein the sensor assembly includes an inductive sensor configured to produce a signal from a door of the container placed in proximity to the inductive sensor.

15. The method of claim 14, wherein the inductive sensor is on the third surface, and wherein the sensor is attached to another door of the container, and wherein the sensor assembly does not interfere with shutting and sealing of the door and the another door of the shipping container.

16. The method of claim 11, wherein the sensor assembly includes a battery, a solar panel, and a processor.

17. The method of claim 11, wherein the sensor assembly includes a humidity sensor, a temperature sensor, and a payload position sensor.

18. The method of claim 17, wherein the battery, solar panel, and the processor are on an opposite side of the assembly from the humidity sensor, the temperature sensor, and the payload position sensor.

19. The method of claim 11, wherein the attaching includes at least one of bolting the sensor assembly around an edge of a door of the shipping container and fitting the sensor assembly into a cut-out of the door.

20. An internal-external tracker for use with cargo, the tracker comprising:
a continuous body having at least a portion in a U-shape such that the body faces an external surface, a door jamb, and an internal surface of the cargo when fixed with a closed door of the cargo;
a wireless communications transceiver in the body facing the external surface; and
a door sensor in the body facing the doorjamb.
